(19) United States
(12) Patent Application Publication
(10) Pub. No.: US 2012/0066978 A1
(43) Pub. Date: Mar. 22, 2012

(54) DEVICE FOR MOVING SLIDING DOORS

(75) Inventors: Giuseppe Caimi, Novedrate (Como) (IT); Adele Caimi, Cantu (CO) (IT)

(73) Assignee: CAIMI EXPORT S.P.A., Novedrate (Como) (IT)

(21) Appl. No.: 13/144,694

(22) PCT Filed: Feb. 22, 2010
(86) PCT No.: PCT/IB2010/000341

§ 371 Date: Oct. 4, 2011

(30) Foreign Application Priority Data
Feb. 23, 2009 (IT) MI2009A000249

(51) Int. Cl. E05D 15/08; E06B 5/00

(52) U.S. Cl. 49/409; 16/94 R

(57) ABSTRACT

A device for moving sliding doors may include a rectilinear guide mountable along the width of an opening reclosable by means of a door, a first bogie slidably movable along the rectilinear guide and connected to a connecting element solidly securable to the door, an auxiliary bogie connected to said connecting element, mounted on the first bogie and free to run along a direction substantially perpendicular to the rectilinear guide, an auxiliary guide in which is engaged the auxiliary bogie, a second bogie slidably movable along the rectilinear guide. The device may include a rotatable arm pivoting on the second bogie and having an end hinged to the connecting element. The rotatable arm is movable between a first position, in which it lies substantially aligned with the rectilinear guide, and a second position, in which it lies substantially perpendicular to the rectilinear guide.

The present invention has as its subject a device for moving sliding doors, in particular for moving doors of cupboards which, in a closed position of the cupboard, are aligned and juxtaposed in the same plane and, in an open position, lie parallel and overlapping.

Known devices which execute this type of movement are, for example, patent EP 1 613 831 and U.S. Pat. No. 4,704,819.

The device of patent EP 1 613 831 comprises, for each of the sliding doors, a bracket fixed solidly to the respective door at an upper edge of the latter. Two longitudinal bogies are slidable on a profile arranged throughout the entire width of the piece of furniture which supports the doors. On each of the longitudinal bogies is mounted a small bogie which can run on the respective bogie in a direction substantially transverse to the profile and is solid with the door. The small bogies are furthermore guided, by means of respective idler rollers, along grooves or cams which extend along the profile and have curved portions.

The device of U.S. Pat. No. 4,704,819 comprises a pair of rollers solid with a door and slidable within a guide solid with the piece of furniture. The roller positioned towards the shoulder of the piece of furniture remains always within said guide, while the other roller, in the closed position of the door, is outside the guide and is secured, by means of a hook, to a pin carried by an arm pivoting on a block solid with the piece of furniture. During opening, a portion of the door is first of all extracted perpendicularly to the guide with a movement guided by the roller and the arm. The arm rotates until it brings the roller into the guide and then releases it. At this point, both the rollers are sliding in guide 1 together with the door.

Both the devices described above are improvable under various aspects, with particular reference, for example, to the precision and fluidity of the opening and closing movements, to their safety and practicality in use on the part of the user, to the robustness of the mechanisms and to their simplicity and compactness.

Furthermore the same devices of the known art are also improvable with reference to the kinematics of the opening movement.

In this context, the technical task at the base of the present invention is to propose a device for moving sliding doors capable of moving the respective door along a predefined path in an extremely precise and fluid manner.

A further object of the present invention is to propose a device for moving sliding doors which, during the movement of the door, avoids any interference between the various elements in movement.

It is also an objective of the invention to make available a precise mechanism which allows opening and closing of doors even of great thickness, while keeping them side by side and extremely close in the closed condition of the piece of furniture.

It is also an object of the present invention to propose a device which is structurally simple, compact and robust.

The declared technical task and the specified objects are substantially achieved by a device for moving sliding doors and by a cupboard, comprising the technical characteristics set forth in one or more of the attached claims.

Further characteristics and advantages of the present invention will become clearer from the indicative, and therefore non-limiting, description of two improving, but not exclusive, embodiments of a device for moving sliding doors, as illustrated in the attached drawings, wherein:

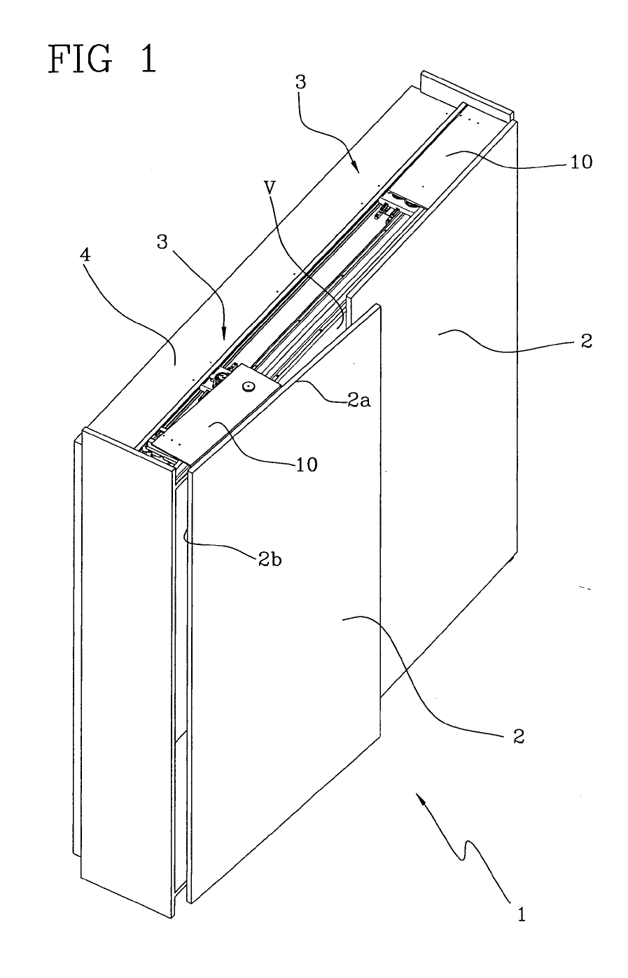

FIG. 1 is a perspective view of a cupboard with sliding doors provided with the device according to the invention;

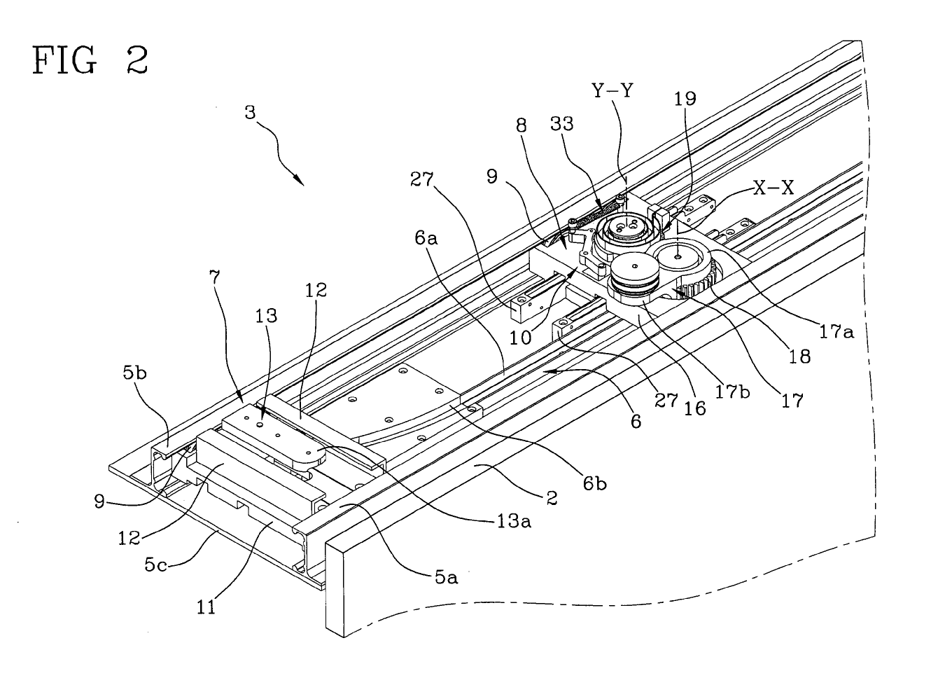

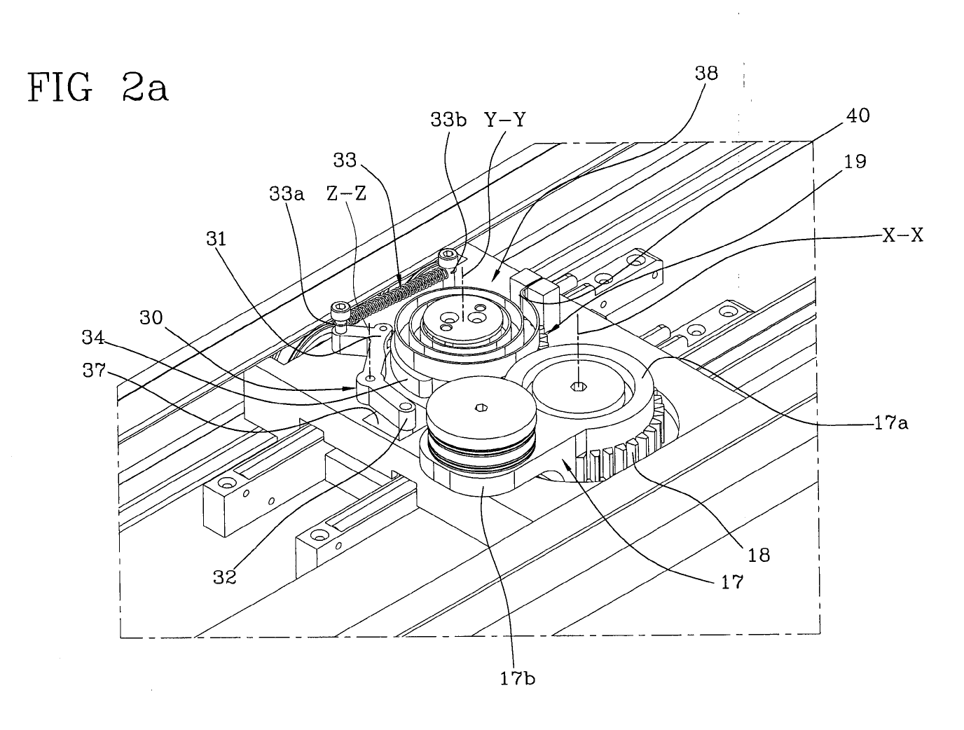

FIG. 2 illustrates an enlarged portion of the cupboard of FIG. 1 with some parts removed to better reveal others, in which the device according to the invention is in a first operative configuration;

FIG. 2a shows a further enlarged element belonging to the portion shown in FIG. 2;

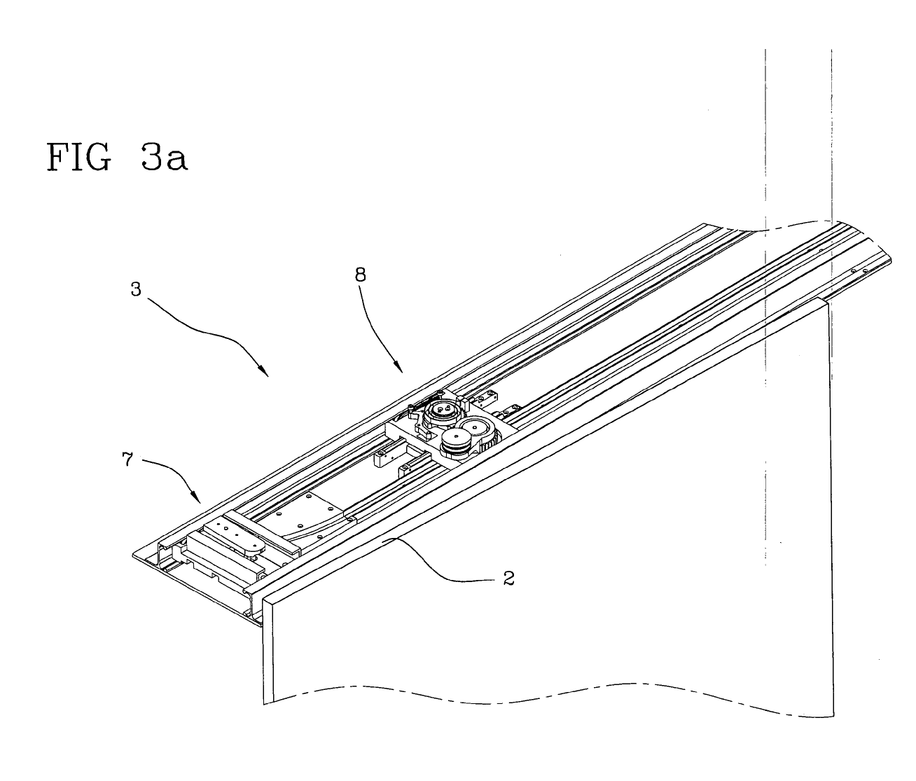

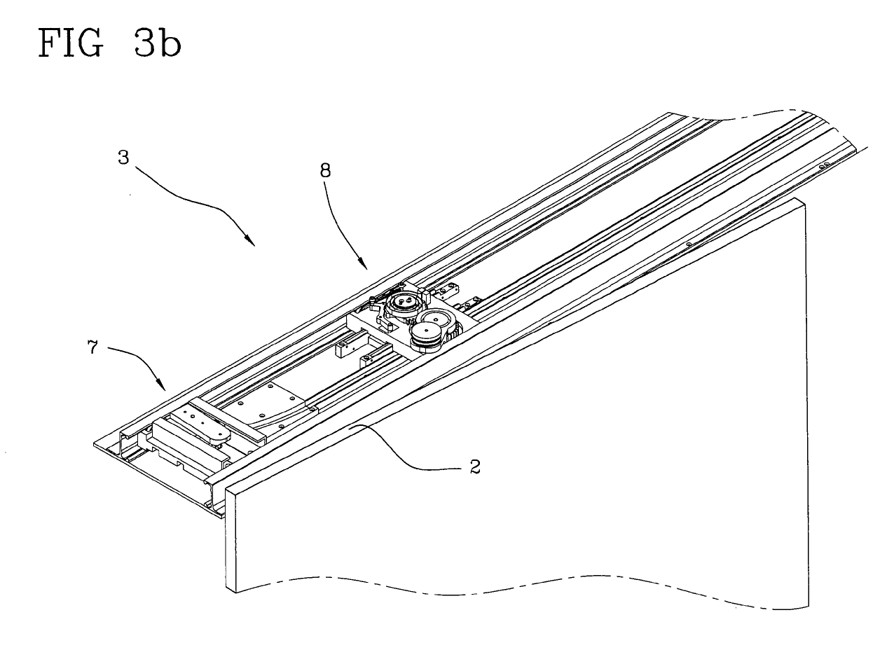

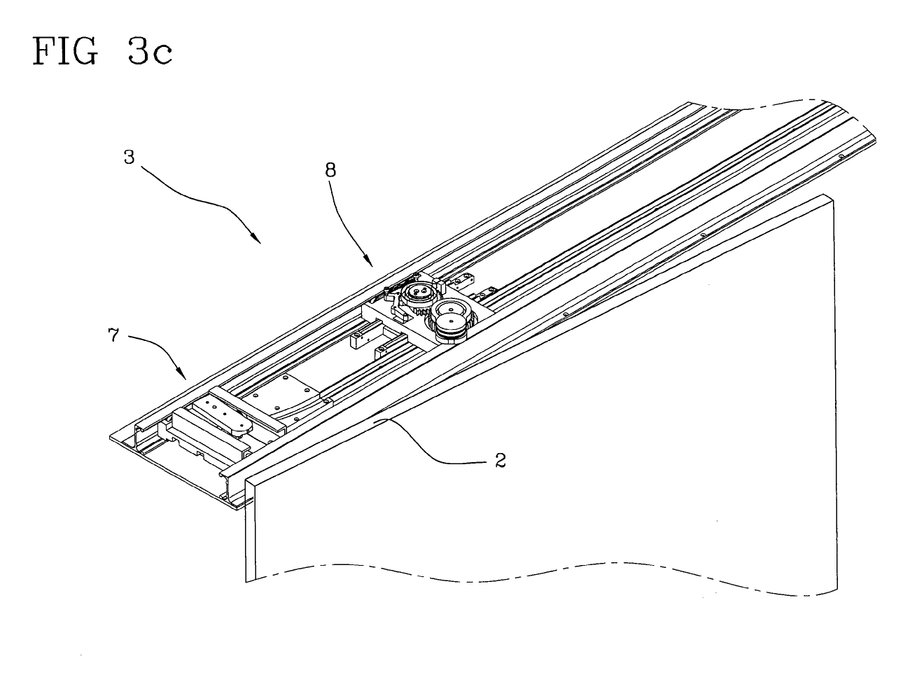

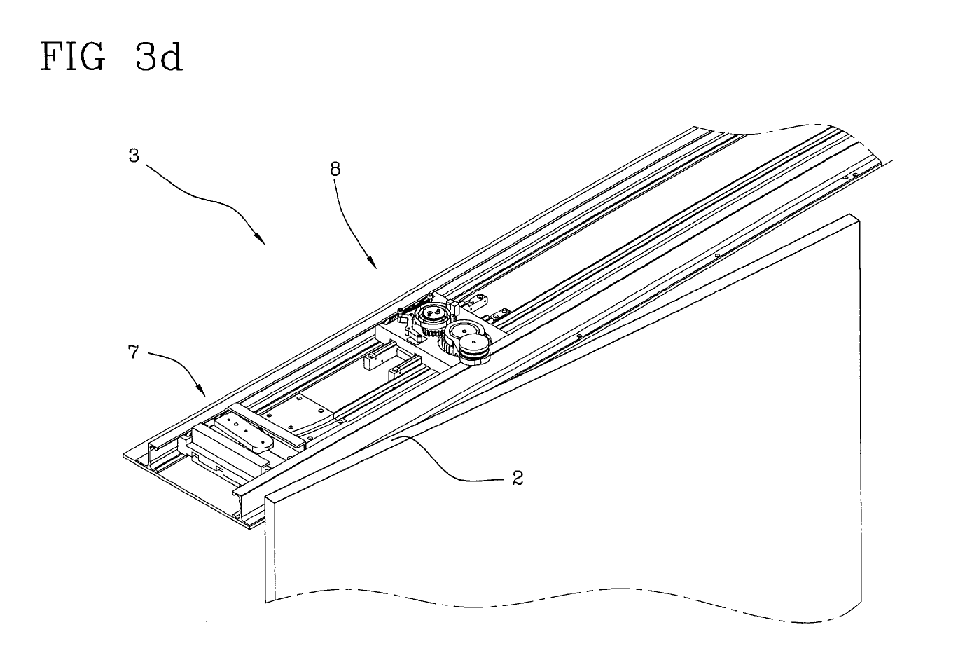

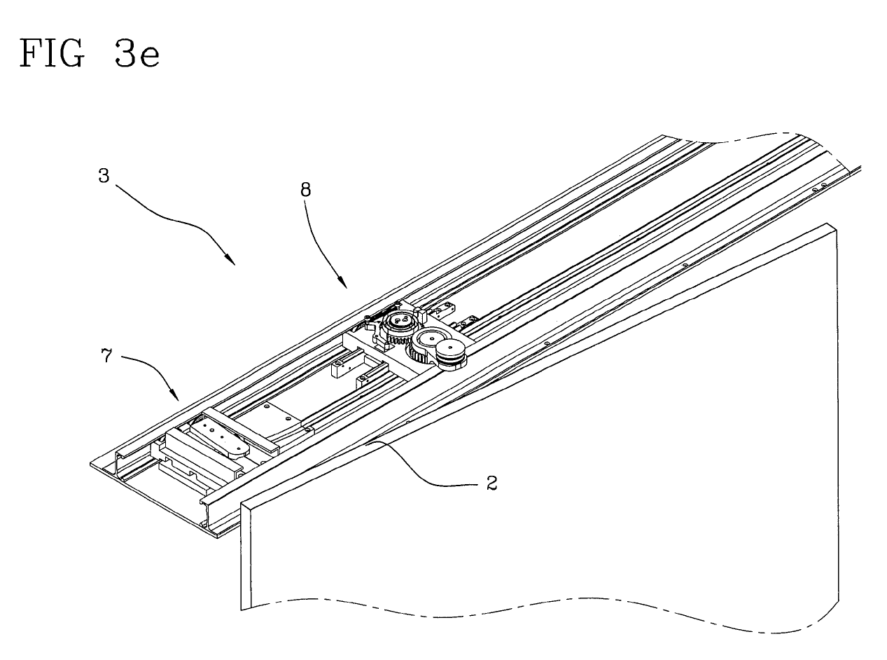

FIGS. 3a-3e illustrate the device according to the invention in successive stages of opening the cupboard;

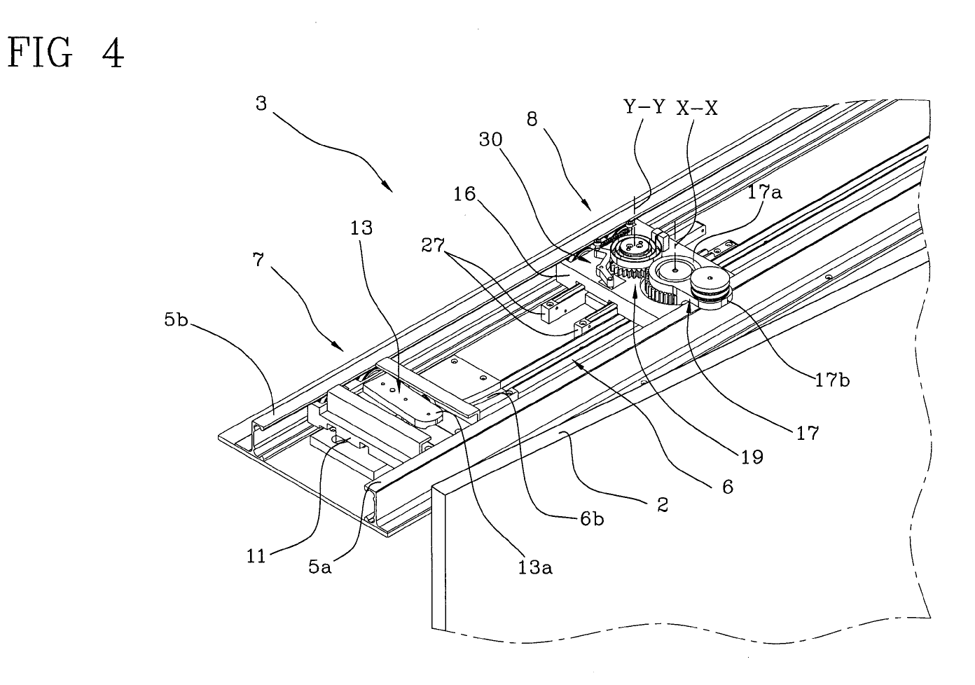

FIG. 4 illustrates the enlarged portion shown in FIG. 2, in which the device according to the invention is found in a second operative configuration;

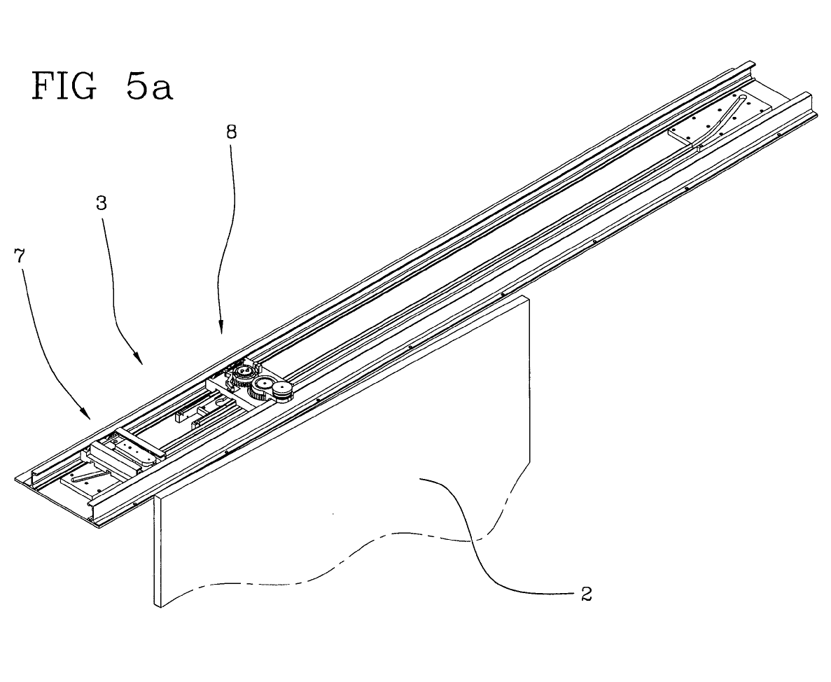

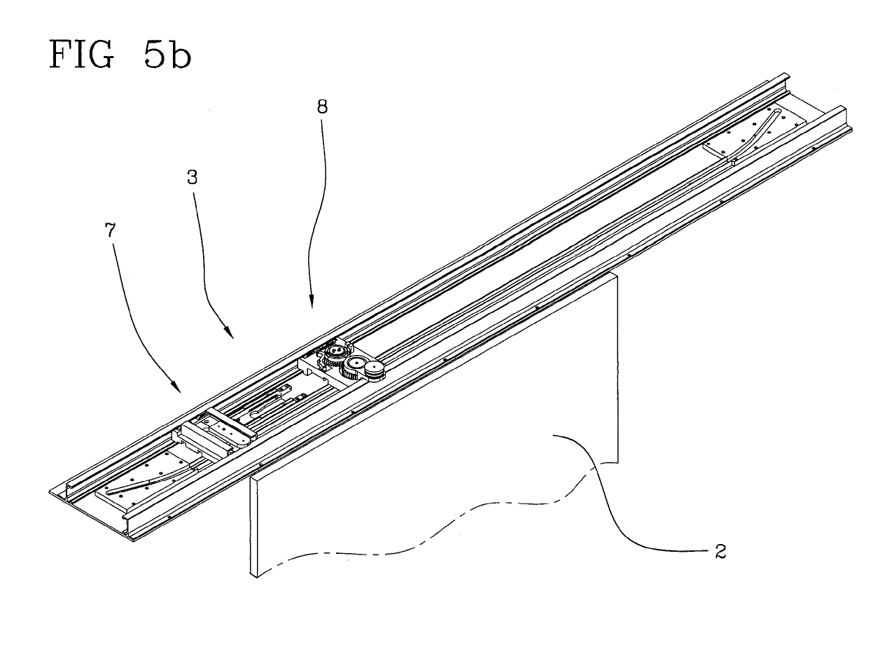

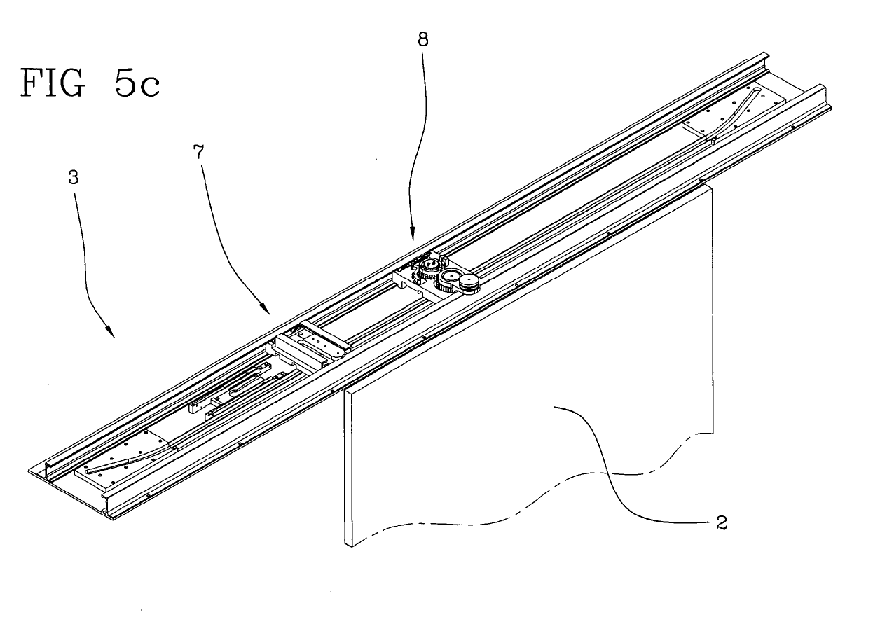

FIGS. 5a-5c illustrate the device according to the invention in successive stages of opening the cupboard;

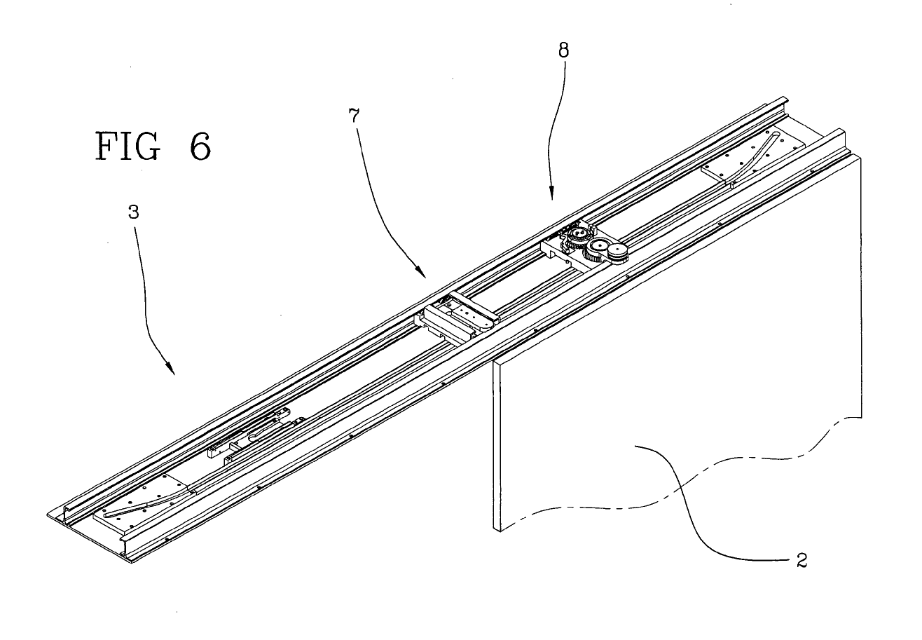

FIG. 6 illustrates the device according to the invention in a third operative configuration;

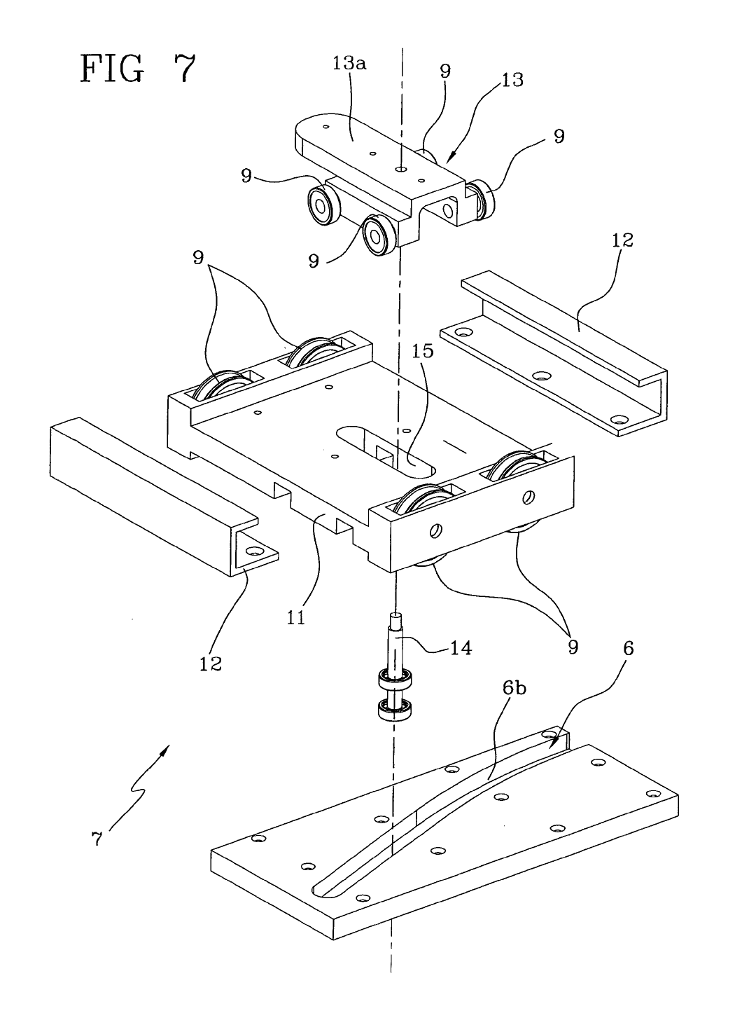

FIG. 7 shows in exploded view a first detail of the device shown in FIGS. 1-6;

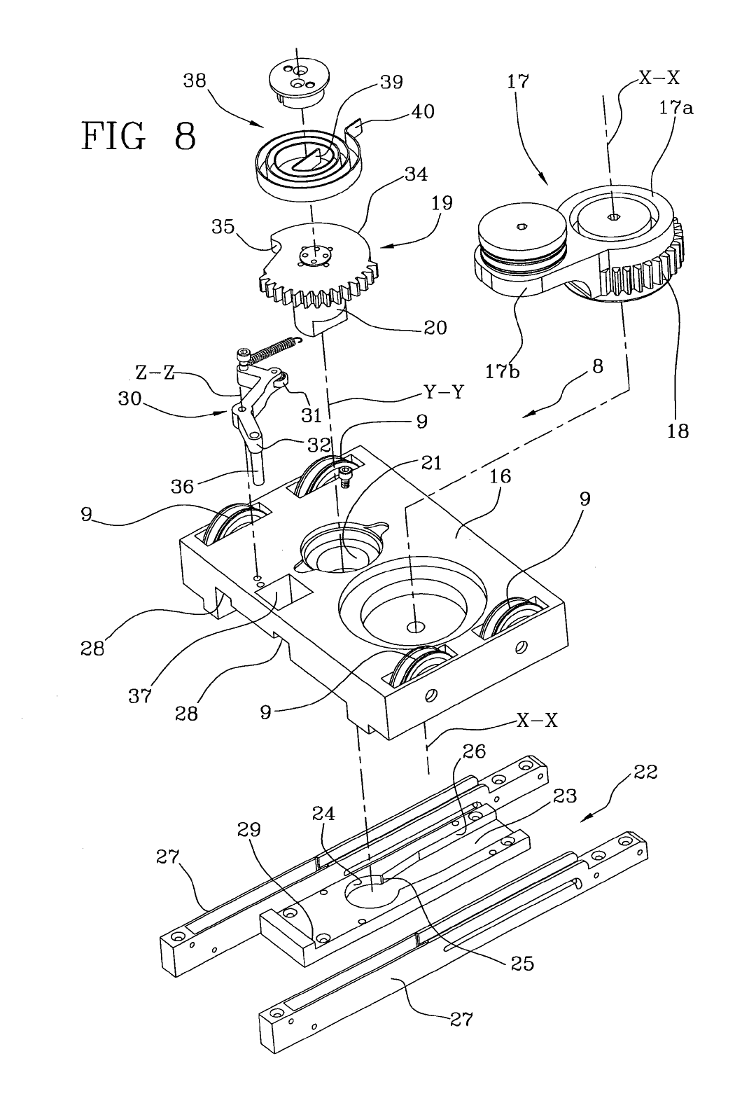

FIG. 8 shows in exploded view a second detail of the device shown in FIGS. 1-6;

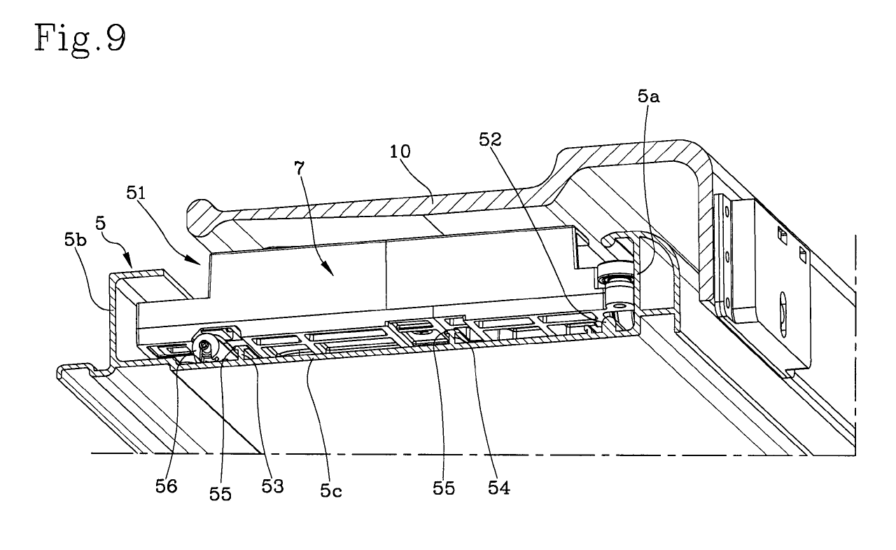

FIG. 9 illustrates a variant embodiment of the device shown in the previous figures which demonstrates the section of the guide;

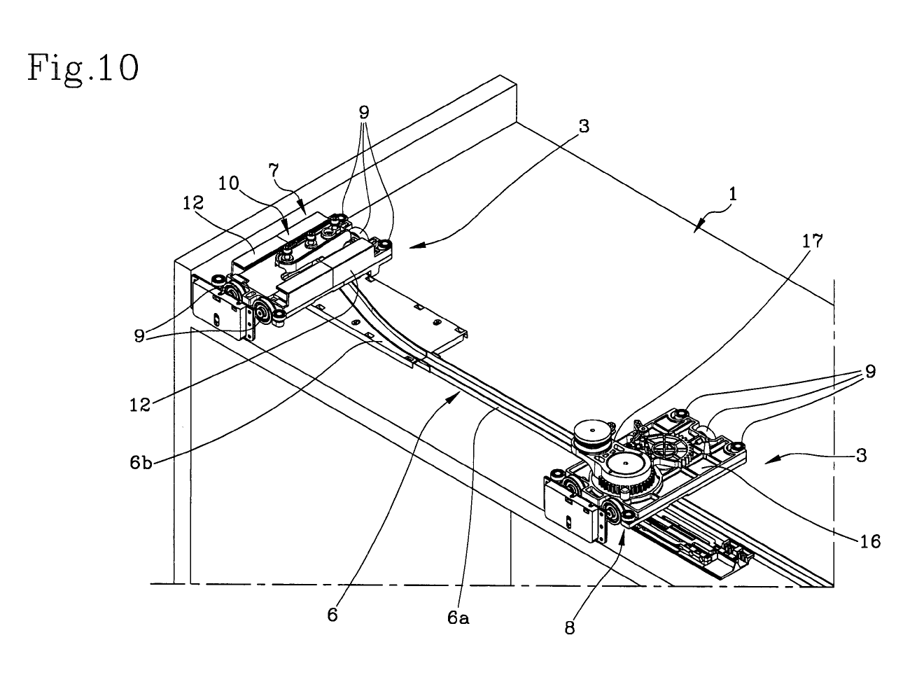

FIG. 10 shows from above the device with some elements removed to demonstrate the presence of two bogies and the guides;

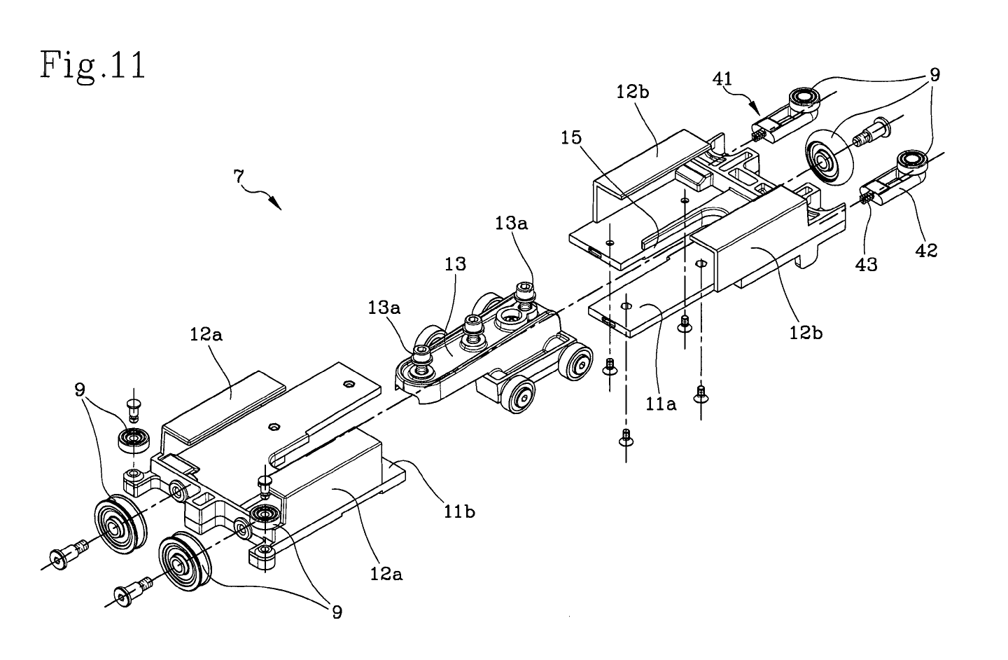

FIG. 11 shows in exploded view the first bogie forming part of the device in accordance with the second embodiment of the invention;

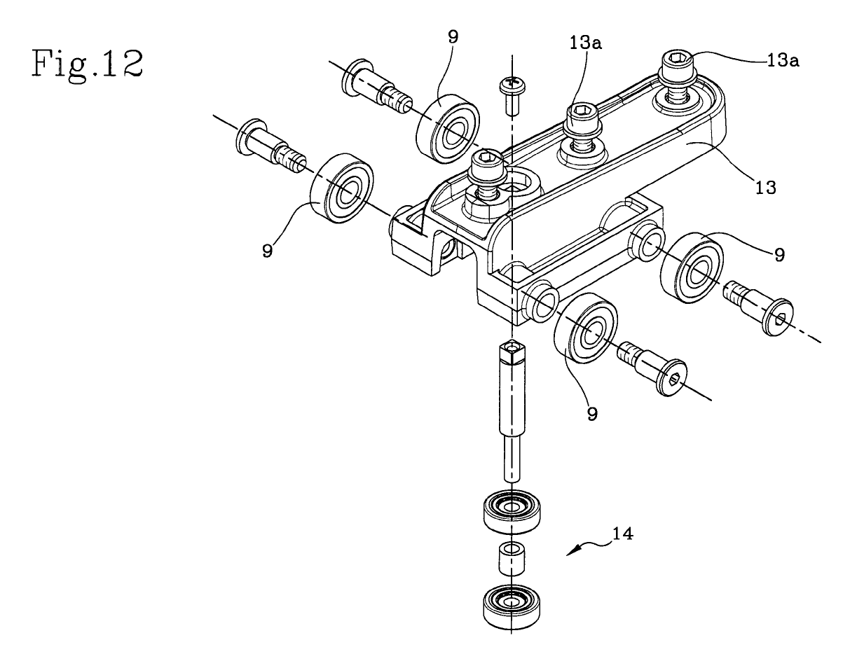

FIG. 12 shows in exploded view the auxiliary bogie of the second embodiment mounted on the first bogie;

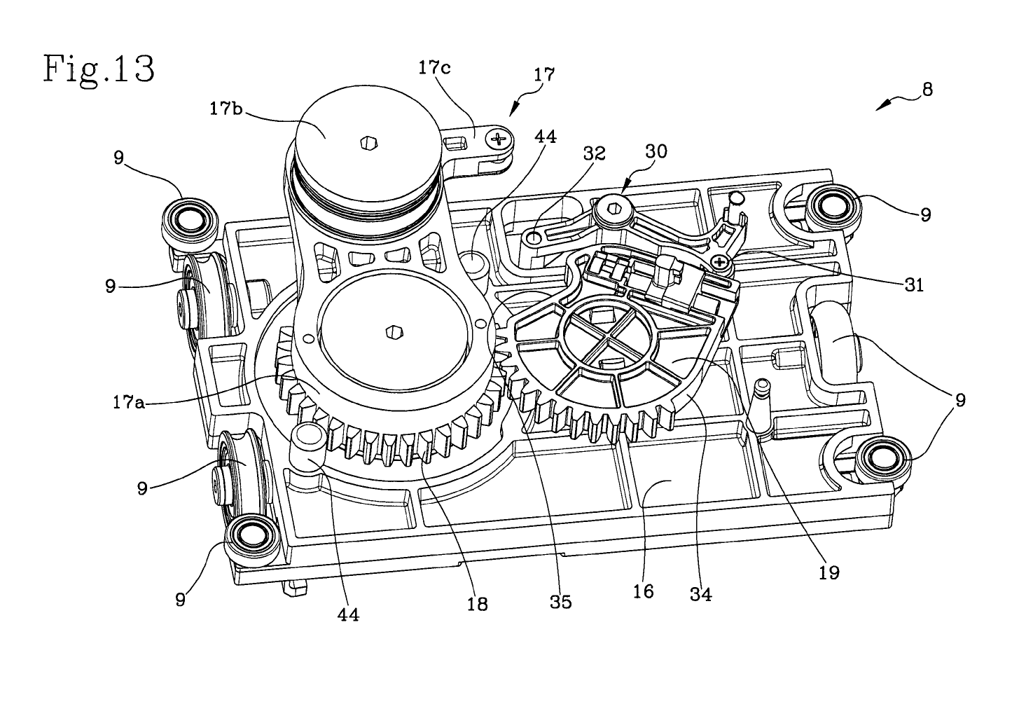

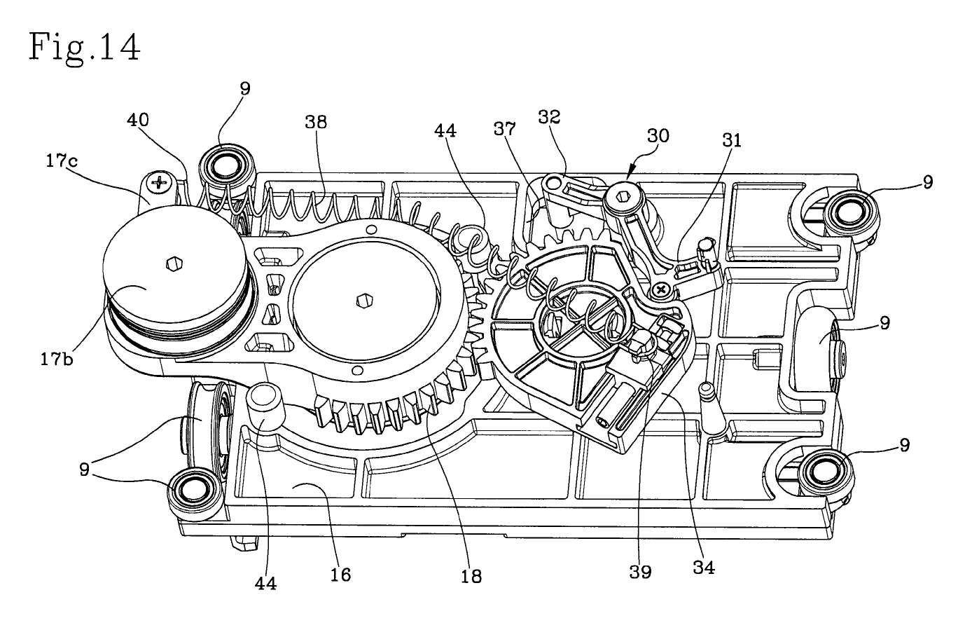

FIGS. 13 and 14 illustrate the second bogie of the second embodiment in two distinct operative configurations;

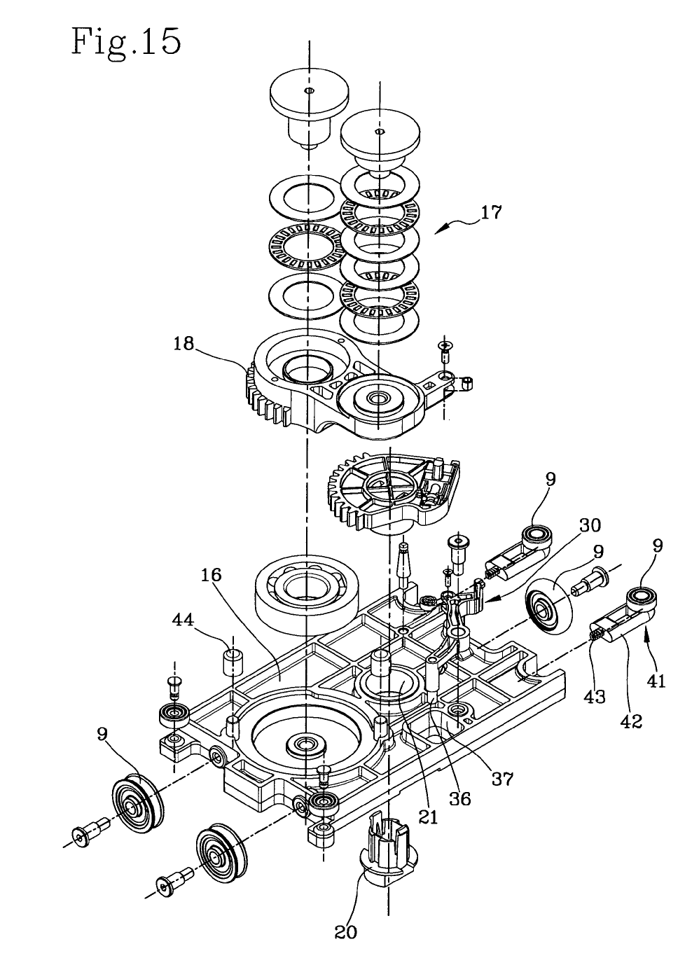

FIG. 15 shows the second bogie of FIG. 13 in exploded view;

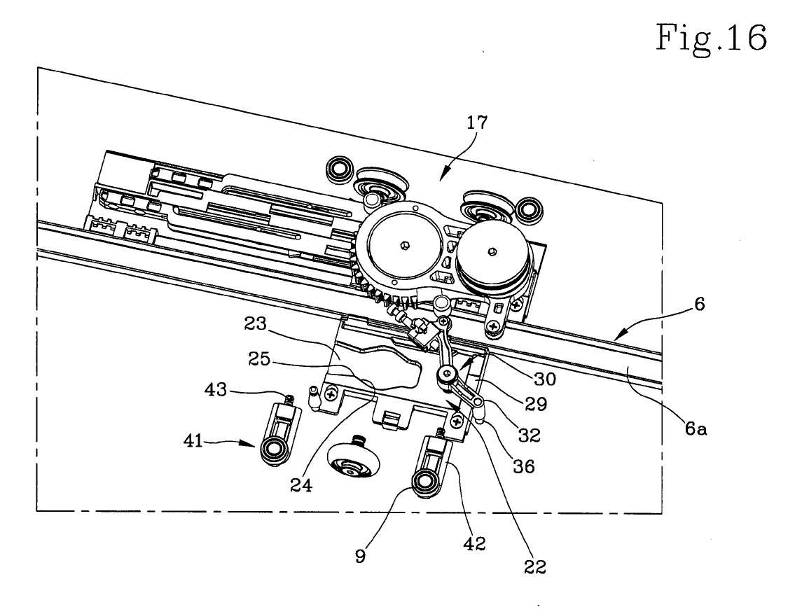

FIG. 16 shows in a view from above some parts making up the second bogie of FIG. 13; and

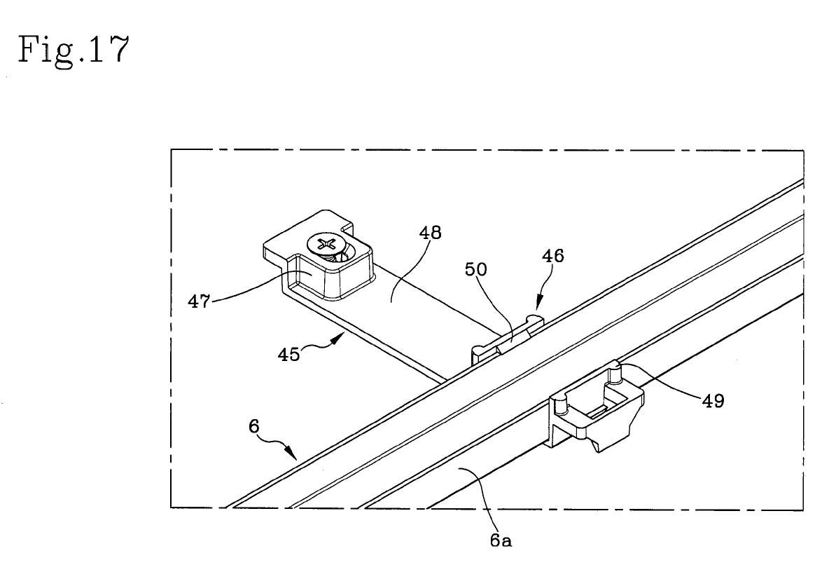

FIG. 17 shows in enlarged view an attachment body to secure the auxiliary guide to the main guide.

With reference to the attached figures, reference number 1 indicates in its entirety a cupboard provided with two or more sliding doors 2 which close an opening “v”. Each of the two doors 2, by means of a device 3 which is the subject of the present invention, is movable between a position of alignment coplanar with the other door 2 (FIG. 2), when the cupboard 1 is closed, and a position of overlapping with respect to the other door 2 (FIG. 6).

The devices 3 are installed/installable on an upper face 4 of the cupboard 1 and are, in particular, arranged as mirror images of each other with respect to a plane of symmetry of cupboard 1 itself.

The two devices 3 comprise a common rectilinear guide 5 which extends for the entire width of the opening “v” of cupboard 1 and comprises in detail two parallel “C”-section profiles 5a, 5b with the concavities facing each other.

As is visible in FIG. 2, the parallel profiles 5a, 5b are formed integrally with, or mounted on, a plate 5c which is installed in its turn on the upper face 4 of cupboard 1.

It is evident that in alternative embodiments the guide 5 could be made in various distinct portions (which could even not be fixed to each other), to separately guide each of the various bogies constituting the device(s).

Obviously the solution with a single rectilinear guide is advantageously cheaper and simpler to make and install.

In an extremely advantageous embodiment illustrated in FIG. 9, the guide 5 forms a housing 51 included between two parallel profiles 5a and 5b and the base plate 5c, a housing which is designed to receive the respective bogies for the movement system, as described below.

The specific embodiment illustrates a guide made as a monobloc, in which the portions forming the parallel profiles 5a and 5b and the base plate 5c constitute the aforesaid single body.

Observing the section of said guide, we note first the presence of a rail 52 designed to receive and guide suitable wheels 9 (with a respective groove) on the movement bogies as described and explained below.

Again observing the section of profile 5 we note also the presence of at least one, and in particular two, restraining elements 53 and 54.

These restraining elements consist of a shank emerging from the plate 5c and at least one suitable undercut 55 which (as illustrated and clarified in FIGS. 9 to 17) enables all the further elements constituting the device to be secured without the need to make holes or carry out other operations of mechanical working on the guide 5 and/or on the cupboard.

In particular the restraining elements 53, 54 have a “T”-section outline so as each to form two undercuts 55, and they lie inside the housing 51.

In these undercuts it is possible to engage by a snap fit or even by means of suitable clamping bolts, all the various further elements of the device in such a way that the entire mechanism and its assembly result in being totally modular.

In fact it is possible to make a single guide 5 with the self-same profile and of the necessary length required, simply by cutting it to the right size.

The guide at this point does not need to have any further work done on it as was necessary in the known art or even in the version shown in FIGS. 1 to 8.

In fact, depending on the dimensions of the doors and of the cupboards, it is necessary to mount the various bogies which constitute the device at different distances along the axis of guide 5.

This can be performed by making suitable drillings at the desired distances and then securing the aforesaid elements by means of screws or bolts (FIG. 2).

Conversely, thanks to the presence of the aforesaid restraining elements 53, 54 which extend longitudinally for the entire length of guide 5, it is possible to make use of them to secure the various elements constituting the bogies in the desired position thanks to the above-mentioned undercuts 55.

The above enormously simplifies the operations of assembling the device and also the operations of making components which are totally standardized, thus ensuring a high level of modularity.

It should be noted that the restraining elements 53, 54 are made in one piece with the guide (in particular by means of the same operation of drawing).

Advantageously, the use of the above-mentioned guide 5 with the restraining elements proves to be usable also independently and with movement systems of the doors other than those disclosed below.

The devices 3 comprise furthermore a common auxiliary guide 6, which is mounted on the plate 5c between the two profiles 5a, 5b, and this too extends substantially for the entire width of cupboard 1. The auxiliary guide 6 has a central rectilinear stretch 6a, parallel to the rectilinear guide 5a, 5b, defined by a further profile with a “C”-shaped section, with its concavity facing upwards. The auxiliary guide 6 has opposed terminal portions 6b with geometry transverse to the central rectilinear stretch, defined in general by curved portions, or at all events oblique to the central stretch 6a, and directed towards a rear portion of the cupboard 1, each optionally defined by a groove formed in a plate mounted on the supporting plate 5c.

In the second embodiment illustrated in FIGS. 9 to 17, the auxiliary guide 6 is presented still defined by a central rectilinear portion 6a and by opposed terminal portions 6b, in an alignment transverse to the central portion, an alignment in detail curvilinear or otherwise.

Its system of mounting to guide 5 is, however, different.

As illustrated in FIG. 17, the rectilinear portion 6a of the guide 6 is secured to the plate 5c of the guide 5 by means of an attachment body 45 (or better by a plurality of attachment bodies spaced axially to each other along the axis of the guide itself).

In particular each attachment body 45 has a fixing portion 46, for example a snap fixing, which receives in a housing 49 within it the above-mentioned “C”-sectioned rectilinear guide and engages it by means of two mutually opposed small teeth 50, capable of acting on the vertical walls of the guide as clearly illustrated in the figure.

In other words, at the assembly stage, the rectilinear portion 6a is pushed into the housing 49 designed to accept it, until the vertical walls of the guide are secured by snap fixing by the teeth 50.

The attachment body 45 also has a support surface 48 designed to stabilize the position of the guide 6 by mating with the flat surface of plate 5c and connecting the securing portion 46 to a retaining element 47 which is designed to become secured by means of, for example, the screw shown in the drawing, to one of the restraining elements 53, 54 previously described.

It is evident therefore that the auxiliary guide 6 can be secured to the plate 5c without the need to intervene on the plate with drillings or other mechanical interventions which would weaken its structural properties and entail further stages of work during the assembly of the mechanism.

Each of the devices 5 comprises a first bogie 7 and a second bogie 8, which are mounted between the two profiles 5a, 5b and are free to run along the rectilinear guide by means of wheels 9 which fit into the profiles 5a,5b themselves.

The two bogies 7, 8 are connected, according to modalities described later, to a connecting element 10 which is solidly secured directly or indirectly to the respective door 2. In the embodiment illustrated (FIG. 1), the connecting element 10 is a connecting plate which extends perpendicularly to the door 2, from an upper edge 2a of the door 2, in particular starting from a lateral shoulder 2b of the door 2 itself, towards the other door 2.

Interposed between the connecting element and the door, a mechanism 60 is provided for adjusting the position, capable of allowing fine adjustments to the door 2 with respect to the body of the cupboard (or with respect also to the connecting element 10), both in a vertical direction and in a horizontal direction.

In other words, the mechanism 60 makes it possible to compensate for fitting errors and/or tolerances in the plane of the door, and these adjustments can, furthermore, be made independently.

In a first embodiment the first bogie 7 is positioned near the above-mentioned lateral shoulder 2b of the door 2 and comprises (FIGS. 2 and 7) a base body 11 which carries four wheels 9. Two “C”-sectioned profiles 12 are mounted on the base body 11 with concavities facing each other, and are arranged in directions perpendicular to the rectilinear guide 5a,5b. An auxiliary bogie 13 is positioned on the first bogie 7 and has four wheels 9, located in pairs in the “C”-sectioned profiles 12. A pin 14 is integral with the auxiliary bogie 13 and extends through a slot 15 formed in the base body 11 as far as the underside of said base body 11, so as to engage in the auxiliary guide 6, by means of for example a roller. The slot 15 extends in length along a direction perpendicular to the rectilinear guide 5a, 5b. The auxiliary bogie 13 can therefore translate and rotate through a predefined angle (around a longitudinal axis of the pin) with respect to the first bogie 7. The auxiliary bogie 13 has a portion 13a connected rigidly to the connecting element 10 (connecting plate).

In the second embodiment, clearly shown in FIGS. 10, 11 and 12, the first bogie 7, while maintaining exactly all the functionalities and peculiarities of the bogie of the first embodiment, has several structural differences.

First of all, the base body 11 is defined by two semiparts (arranged longitudinally with respect to the axial extension of the guide 5), a first semipart 11a and a second semipart 11b which, coupled together, define it.

In addition each of the two semiparts 11a and 11b of the base body 11 carries integrally the respective portions 12a and 12b designed, in cooperation, to define the above-mentioned “C”-sectioned profiles 12.

In other words again, the second embodiment is differentiated by the fact that the structure is created in two semiparts couplable along a corresponding axis instead of being made up of one plate and two separate guides.

The above produces simplifications at a production level.

From the point of view of the movement we note the presence of two wheels 9 with suitable grooves designed to run in the rail 52 of guide 5.

Also on the same side of the first bogie 7 are two further small wheels with vertical axis 9, designed to butt against the vertical surface of the rectilinear profile 5a.

On the opposite side there is a single wheel 9 with horizontal axis which moves freely on the horizontal base surface of the rectilinear profile 5b.

There are also two further wheels 9 with vertical axis, mounted on adaptor elements 41 made up of a wheel-carrying body 42 and a suitable spring 43.

The wheel-carrying body 42 is mounted slidably inside a housing counter-profiled to the base body 11 in such a way as to be able to position the wheels with vertical axis 9 more or less close to the base body itself.

The springs 43 thrust the wheels with vertical axis 9 outwards in such a way as to make them butt against the vertical surface of the rectilinear guide 5b during the operation of the device (in this way any constructional tolerances are compensated and the effects of misalignment during movement are minimized, also avoiding any sticking of the device).

Operating in this manner, i.e. by controlling the movements of first bogie 7 both with wheels with horizontal axis, and with wheels with vertical axis (possibly adjustable), enables movement without sticking, simplified, fluid and smooth.

The further parts of the device are substantially unchanged, while displaying some geometrical alterations with respect to the first embodiment.

In fact, looking particularly at FIG. 12, we note the presence of the auxiliary bogie 13 and of the respective portions 13a designed to engage with the connecting element 10.

There is also a pin 14 fixed to the auxiliary bogie and capable of sliding in a slot 15 formed in the base body 11.

The second bogie 8 is positioned at an intermediate portion of the door 2 and comprises (FIGS. 2, 2a and 8) a base body 16 which carries four wheels 9. The base body 16 has a rotatable arm 17 pivoting on it, which has a first end 17a hinged to the base body 16 around a first axis of rotation “X-X” and provided with at least one toothed peripheral portion 18. A second end 17b of arm 17 is securable rotatably to the connecting element 10 (connecting plate 10), for example by thrust bearings.

The rotatable arm 17 is movable between a first position (FIG. 2), in which it lies substantially aligned with the rectilinear guide 5a, 5b, and a second position (FIG. 4), in which it lies substantially perpendicular to said rectilinear guide 5a, 5b.

The base body 16 of the second bogie 8 also has mounted rotatably on it, around a second axis of rotation “Y-Y”, a wheel at least partially toothed which engages with the teeth of arm 17. The wheel 19 carries on its underside and solid with it a pin 20 (shown as one piece in FIG. 8; in FIG. 15 shown coupled removably by a snap fitting) which passes through a hole 21 formed in the base body 16 and projects below the latter. The pin 20 has one of its terminal extremities equipped with a non-circular transverse section, particularly substantially rectangular.

On plate 5c, between the two profiles 5a, 5b and adjacent to the auxiliary guide 6, is fixed a further guide element 22 which delimits a recess 23.

The recess 23 defines a housing 24, either circular (FIG. 8) or extended (FIG. 16), having a lateral opening 25, which opening 25 lies in the direction of sliding of door 2, i.e. on the opposite side from the portion of transverse extremity 6b of the auxiliary guide 6. In other words, in the first embodiment the lateral wall of said circular housing 24 extends for an arc of a circle greater than 180° but less than 360°, such that the passable section of the above-mentioned lateral opening 25, measured perpendicularly to the rectilinear guide 5a, 5b, is less than the diameter of the circular housing 24.

The diameter of the housing 24 is substantially equal to (slightly greater than) the maximum dimension of the circular section of the pin 20. The passable section 25 of the circular housing 24 is smaller than the above-mentioned diameter and is substantially equal to (slightly greater than) the minimum dimension of the non-circular section of the pin 20. The pin 20 and the circular housing 24 form part of means to lock the second bogie 8 onto the rectilinear guide 5a, 5b until the rotatable arm 17 is in the second position, as explained in detail further on.

Preferably, the recess 23 also has a substantially rectilinear stretch 26 which extends from the above-mentioned passage 25 parallel to the rectilinear guide 5a, 5b and is open in the direction of sliding of door 2 when it opens.

Furthermore the guide element 22 optionally comprises furthermore a pair of projections 27 fixed onto the plate 5c which extend partially parallel to the rectilinear guide 5a, 5b and lie alongside the recess 23. Projections 27 can slide inside recesses 28 formed on a lower face of the base body 16 of the second bogie 8 (in reality the recesses 28 slide on the projections 27).

The guide element 22 comprises furthermore a reaction piece particularly defined by a surface perpendicular to the rectilinear guide 5a, 5b and facing in the direction of sliding of door 2 when it opens.

Again with reference to the second embodiment illustrated in FIGS. 9 to 17, also the second bogie presents several differences from the first embodiment, while maintaining its functionalities unaltered.

First of all we note the presence of a helicoidal spring 38 which connects a spring-retaining end 17c of the rotatable arm to an attachment zone present on the wheel 19.

In particular when the rotatable arm is found in the extracted position (FIG. 14), the spring is loaded, but the first end 31 of the lever 30 blocks the wheel 19 from rotating.

When the bogie returns into proximity to the closure zone of the door, the lever 30 is disengaged as is more fully clarified below, the wheel 19 can rotate and the spring 38 assists the closure by rotation of arm 17.

It should be noted that the spring 38 has been represented only in FIG. 14, but obviously, even if it is not shown, it is present also in the configurations in the rest position, shown in FIG. 13.

The only further differences with respect to the bogie previously described are connected with the movement system of the bogie and fully resemble those used on the first bogie 7 illustrated in FIGS. 10-12.

In particular we note the presence of two wheels with horizontal axis, provided with a groove and capable of running in the above-mentioned rail 52 of guide 5.

Also present are the wheels 9 with vertical axis, fixed so as to bear against the vertical wall of the rectilinear guide 5a.

On the opposite side there is a wheel with a horizontal axis, free to run on the base surface of guide 5b, and two wheels with vertical axis, adjustable as previously described, i.e. by the above-mentioned adaptor elements 41, as well as the wheel carrier body 42 and the spring 43.

In addition, compared with the version shown in FIGS. 1 to 9, two rotation stops 44 have also been introduced which define the maximum excursion of rotation of the rotating arm 17 and the position of maximum rotation of the same arm in closure conditions.

In this connection, see FIGS. 13 and 14.

As is also visible in FIG. 15, the pin 20 is solidly fixed to the wheel 19 by means of a snap retainer.

In other words, the two elements are integral in movement, but not made in one piece as in the first version.

Looking next at FIG. 16, we note that the further guide element 22 also has a recess 23, with geometry, however, different from that of the first embodying solution.

The structural operation remains absolutely the same, in that the head of pin 20 is identical to that of the first embodiment, and has a configuration in which it is permitted to enter and exit at the lateral opening 25, and a rotated configuration (generally by 90°) in which the head does not allow the bogie to run because the pin 20 is locked in the housing 24.

In this embodiment the housing has two lateral portions with a curved outline, substantially circular, capable of accommodating the pin 20 in rotated configuration.

All the other elements making up the second bogie 8 are conversely substantially identical to those of the first embodiment, previously described.

On the base body 30 of the second bogie 8, a lever 30 is pivoted (FIG. 2a) which is rotatable about a third axis of rotation “Z-Z” and has a first end 31, preferably provided with a roller, and a second end 32, opposed to the first 31.

A spring 33 pulls, or pushes, the first end 31 of the lever 30 against a peripheral portion 34, preferably deprived of teeth, of the wheel 19. The spring 33 has a first end 33a fixed adjacent to the first end 31 of the lever 30 and a second end 33b fixed to the base body 16.

The peripheral portion 34 of the wheel 19 is also shaped to define an indentation provided with an arresting surface 35 (FIG. 8) lying in a plane containing the second axis of rotation “Y-Y”.

The second end 32 of the lever 30 has a lug 36 which passes through an opening 37 formed in the base body 16 and projects below the latter, to interact, as will be detailed later, with reaction piece 29.

A spring 38 is also mounted on the wheel 19 to detain arm 17 in the first position. In particular in the first embodiment (FIGS. 2a and 8), the spring 38 is of the spiral type and has an end 39 (visible in FIG. 8) fixed to wheel 19 and to an opposite end 40 fixed to the base body 16.

At a lower edge 2b of door 2, i.e. at the foot of the cupboard 1, there may be present devices similar to that just described, or guides of a type in itself known and therefore not described here.

In use, when door 2 is closed and lies coplanar with the other door 2, the first bogie 7 is positioned above the end of the terminal portion 6b of the auxiliary guide 6. The auxiliary bogie 13 is perpendicular to the rectilinear guide 5a, 5b and lies in a completely rearward position with respect to the opening of cupboard 1, on the first bogie 7 (FIG. 2).

The second bogie 8 lies above the guide element 22 with the arm 17 in the first position (in which it lies aligned with the rectilinear guide 5a, 5b). The pin 20 is inserted into the housing 24 and rotated in such a way that it cannot pass through the passable section 25. The pin 20 imprisoned in this position therefore prevents the sliding of door 2 parallel to the rectilinear guide 5a, 5b.

The spiral spring 34 is substantially loaded and the first end 31 of the lever 30 lies against the peripheral portion 34 of the wheel, distanced however from the arresting surface 35 (FIGS. 2 and 2a).

When the user pulls the door 2 towards himself/herself, by means for example of a handle positioned in an area close to the other door 2, this causes the rotation of the lever 17 which, by means of the toothed coupling, makes the wheel 19 also rotate, in opposition to the spiral spring 38. Door 2 is brought into an inclined position with respect to the rectilinear guide 5a, 5b and with respect to the other door 2 (sequence shown in FIGS. 3a-3e and 4).

The displacement along an arc of a circle of the second end of the lever 17 also brings about a displacement of door 2 with respect to the rectilinear guide 5a, 5b. In consequence the first bogie 7 begins to move closer to the second bogie 8 and, simultaneously, the auxiliary bogie, (integral with door 2) rotates around the axis of the pin 14 in a direction of rotation opposite to that of arm 17.

The travel of the first bogie 7 along the rectilinear guide 5a, 5b also brings about the translation of the auxiliary bogie 13 over the self-same first bogie 7, since the pin 14 is obliged to follow the curved terminal portion 6b of the auxiliary guide 6.

The pin 20 also rotates in its housing 24 together with the wheel 19, while the first end 31 of the lever 30 slides, or rolls, on the peripheral portion 34 until the arm 17 has reached the second position (in which it lies substantially perpendicular to the rectilinear guide 5a, 5b).

Once this second position has been reached (FIG. 4), the wheel 19 has executed a rotation such as to bring the arresting surface 35 into contact with the first end 31 of the lever 30. This first end 31, detained by the spring 33 against the arresting surface 35, prevents arm 17 from being able to rotate in the opposite direction and prevents the door 2 from being able to return to proximity with the cupboard 1.

Furthermore, it is only once this second position has been reached that the pin 20 has executed a rotation such as to allow it to pass through the passable section 25. The first bogie 7 and the second bogie 8, together with door 2, can therefore be moved by the user along the rectilinear guide 5a, 5b. By means of this movement, the first bogie is brought onto the rectilinear stretch 6a of the auxiliary guide 6 and the auxiliary bogie 13 runs over the first bogie 7 until it reaches a position of complete extraction with respect to cupboard 1 (FIG. 5b). Door 2 at this point lies parallel to the rectilinear guide 5a, 5b and to the other door 2, but on an offset plane and can therefore be translated until it overlaps said other door (not illustrated in FIGS. 5c and 6).

During closure, door 2 travels the trajectory in the opposite direction. When the second bogie 8 reaches the guide element 22 and the pin 20 re-enters the circular housing 24, the lug 36 on the lever 30 comes into contact with the reaction piece 29, which makes the lever 30 rotate and temporarily distances the first end 51 from the arresting surface 35. The wheel 35, no longer locked by the lever 30, turns, pulled by the spring 38, bringing the pin 20 back into the locked position in the housing 24 itself, and bringing about the rotation of the arm 17 which is brought back into the first position, bringing the door 2 closer to the cupboard 1.

The present invention achieves the proposed objects and achieves important advantages.

The device according to the present invention ensures a precise movement of opening and closure of the door by means of a structure that is simpler and more compact than those of the known art.

The device under examination is consequently robust, reliable and inexpensive and can easily be fitted to cupboards of various dimensions.

The device under examination furthermore makes it possible to avoid any interference by the door itself with other parts of the cupboard. The sliding of the door into a position where it overlaps the other door can occur only when the arm 17 is locked in the second position (by means of the lever 30 engaged against the arresting surface 35) and holds the door distanced from the remaining parts of the structure of the cupboard. Furthermore, when the door is closed across the opening and aligned with the other, it is not possible to translate it laterally because the pin 20 is imprisoned in the respective housing 24.

The terminal stage of the closure movement of the door is accompanied by the action of the spiral spring 38 which also prevents the door itself from being able to remain partially open.

It should be noted finally that the above-mentioned guide 5 equipped with the restraining elements proves to confer advantages in assembly independently of the presence of the kinematics described, and particularly comprising the first bogie 7 which is slidably movable along the rectilinear guide 5a, 5b, connected to a connecting element 10 which is solidly securable to the door 2; an auxiliary bogie 13 mounted on the first bogie 7 and free to run, with respect to said first bogie 7, in a direction transverse to the rectilinear guide 5a, 5b; said auxiliary bogie 13 being connected to a connecting element 10 solidly securable to the door 2; the auxiliary bogie 13 being guided by said auxiliary guide 6; the second bogie 8, slidably movable along a rectilinear guide, in particular said rectilinear guide 5a, 5b; the rotatable arm 17 pivoting on the second bogie 8 and having an end 17b pivoting on said connecting element 10; the rotatable arm 17 movable between the first position, in which it lies substantially aligned with the rectilinear guide 5a, 5b, and the second position, in which it lies transverse to said rectilinear guide 5a, 5b.

1-14. (canceled)

15. A device of moving sliding doors, comprising:
a rectilinear guide mountable along the width of an opening reclosable by means of a door;
a first bogie slidably movable along said rectilinear guide;
an auxiliary bogie mounted on the first bogie and free to run, with respect to said first bogie, in a direction transverse to the rectilinear guide, said auxiliary bogie being connected to a connecting element solidly securable to the door;
an auxiliary guide having a rectilinear portion substantially parallel to the rectilinear guide and an end portion which extends transversely to the rectilinear portion with respect to the rectilinear portion, the auxiliary bogie being guided by said auxiliary guide;
a second bogie, slidably movable along a rectilinear guide; and
a rotatable arm pivoting on the second bogie and having an end pivoting on said connecting element, the rotatable arm being movable between a first position, in which the rotatable arm lies substantially aligned with the rectilinear guide, and a second position, in which the rotatable arm lies transverse to said rectilinear guide.

16. The device according to claim 15, comprising a locking assembly locking the second bogie onto the rectilinear guide until the rotatable arm is in the second position.

17. The device according to claim 15, comprising a locking assembly locking the rotatable arm in the second position while the second bogie is free to run on said rectilinear guide and unlocking the rotatable arm from the second position when the second bogie is locked onto the rectilinear guide.

18. The device according to claim 15, wherein the auxiliary bogie is rigidly connected to said connecting element and is free to rotate with respect to the first bogie in accordance with a predefined angle.

19. The device according to claim 15, wherein the first bogie is positioned near a lateral shoulder of the door and the second bogie is positioned adjacent to an intermediate portion of said door.

20. The device according to claim 16, wherein the locking assembly locking the second bogie onto the rectilinear guide comprises a pin movable, by means of the rotation of the rotatable arm, between a first position, in which the pin lies locked in a housing, and a second position, in which the pin is free to come out of said housing and move along the rectilinear guide.

21. The device according to claim 20, wherein the locking assembly locking the second bogie onto the rectilinear guide comprises a wheel at least partially toothed, integral with the pin, rotatably mounted on the second bogie and meshing with teeth located on a peripheral portion of the rotatable arm.

22. The device according to claim 20, comprising furthermore a spring configured for detaining the rotatable arm in the first position.

23. The device according to claim 21, wherein the locking assembly comprises a lever pivoting on the second bogie and a spring capable of thrusting a first end of the lever against a peripheral portion of the wheel; said peripheral portion of the wheel having an arresting surface configured for accommodating the first end of the lever when the rotatable arm is in the second position.

24. The device according to claim 23, wherein the locking assembly comprises a reaction piece fixed with respect to the rectilinear guide and interacting with a second end of the lever opposite to the first with respect to a fulcrum of said lever.

25. The device according to claim 15, wherein the guide comprises at least one restraining element having at least one undercut configured for allowing the securing to the guide itself of the auxiliary guide and of the first bogie and of the second bogie.

26. The device according to claim 25, wherein the restraining element has a “T” section defining two undercuts.

27. A cupboard with sliding doors having at least one device of moving sliding doors, comprising:
a rectilinear guide mountable along the width of an opening reclosable by means of a door;
a first bogie slidably movable along said rectilinear guide;
an auxiliary bogie mounted on the first bogie and free to run, with respect to said first bogie, in a direction transverse to the rectilinear guide, said auxiliary bogie being connected to a connecting element solidly securable to the door;
an auxiliary guide having a rectilinear portion substantially parallel to the rectilinear guide and an end portion which extends transversely to the rectilinear portion with respect to the rectilinear portion, the auxiliary bogie being guided by said auxiliary guide;
a second bogie, slidably movable along a rectilinear guide; and
a rotatable arm pivoting on the second bogie and having an end pivoting on said connecting element, the rotatable arm being movable between a first position, in which the rotatable arm lies substantially aligned with the rectilinear guide, and a second position, in which the rotatable arm lies transverse to said rectilinear guide.

28. A cupboard according to claim 27, comprising two doors, each connected to a device and movable between a position of alignment coplanar with the other door and a position of overlapping with respect to the other door, in which the rectilinear guide and the auxiliary guide are common to the two devices.
